(19) United States
(12) Patent Application Publication
(10) Pub. No.: US 2019/0011972 A1
(43) Pub. Date: Jan. 10, 2019

(54) POWER MANAGEMENT SYSTEM THAT DISPLAYS BACKGROUND COLORS TO INDICATE BATTERY STATUSES

(71) Applicant: CYBER POWER SYSTEMS INC., Taipei (TW)

(72) Inventors: Ta-Peng CHEN, Taipei City (TW); Yung-Hao PENG, Taipei City (TW); Yu-Yao CHIU, Taipei City (TW)

(21) Appl. No.: 15/641,839

(22) Filed: Jul. 5, 2017

(51) Int. Cl. G06F 1/32

(52) U.S. Cl. CPC G06F 1/3212; G06F 1/3218; G06F 1/3265; G06F 1/3287

(57) ABSTRACT

A power management system that indicates battery statuses by displaying background colors includes a power management device with a display, at least one sensor, and at least one battery set. The at least one sensor is connected to the power management device and the at least one battery set to detect the statuses of the at least one battery set and to send detection information to the power management device. According to the management items, the power management device enables the display to use different background colors to show the statuses of the at least one battery set. The maintenance person can quickly and clearly know current status of the at least one battery set for assurance of fast maintenance and easy management of the power management system.

### BACKGROUND OF THE INVENTION

### 1. Technical Field

The invention relates to a power management system and, in particular, to a power management system that displays background colors to indicate battery statuses.

### 2. Description of Related Art

Currently, a control room is configured with servers, communication devices or power systems for the purpose of processing a huge amount of information or providing electrical power. However, with the rapid development in network speed and tremendous information to be processed, the control room also becomes bigger and bigger in order to increase the information processing speed and provide sufficient electrical power. Therefore, managing the control room in an effective way has become a trend.

Take a power system as an example. As electrical/electronic equipment requires higher power, more electrical power will be consumed. In order to provide sufficient electrical power to electrical/electronic equipment, the power system needs to have more batteries and thus more complicated wiring. In order to increase the efficiency of maintaining and managing the control room, one method is to distinguish wires by different colors and to group wires of the same color. Another method is to associate battery sockets or connection ports with different colors and to connect the sockets or connection ports of the same color together. Those methods put batteries of the same power supply targets or of the same power consumption into the same group. Battery management is thus more convenient through grouping by colors.

Management of grouped battery has the advantage of managing batteries more easily. However, when some battery is out of order, the maintenance person at the control room only knows how many groups of batteries are out there. The person still needs to check the groups one by one to find the group with the faulty battery. As the maintenance person cannot rapidly and effectively identify the faulty battery group, it takes more manpower and time in maintenance. It may sometimes get into a dangerous situation if the faulty battery fails to be repaired in time.

### SUMMARY

In view of the foregoing drawbacks of conventional techniques, the invention provides a power management system that displays background colors to indicate the statuses of a battery. With different background colors in display, the maintenance person can more directly and rapidly find the group with a faulty battery, thereby increasing the maintenance speed and management convenience.

To achieve the above-mentioned objective, the power management system includes at least one battery set, at least one sensor, and at least one management device.

Each of the at least one battery sets includes a plurality of batteries for providing and storing electrical power.

Each of the at least one sensor is connected to a corresponding battery set to detect a current status of the corresponding battery set and generate detection information.

Each of the at least one power management device includes a processor, a first connection port, and a display. The first connection port is connected to the at least one sensor to receive the detection information and send the detection information to the processor, and the processor generates status information according to the received detection information and enables the display to show a background color corresponding to the status information.

From the above-mentioned structure, given the display using the background color to indicate the current status of the associated battery set, the maintenance person can quickly identify the faulty battery set by checking the background colors of the displays. Thus, the goals of enhancing maintenance efficiency and facilitating easy management of the power management system can be achieved.

### BRIEF DESCRIPTION OF THE DRAWINGS

FIG. 1 is a functional block diagram showing a first system architecture according to the first embodiment of the invention;

FIG. 2 is a functional block diagram showing a second system architecture according to the first embodiment of the invention;

FIG. 3 is a functional block diagram showing a system architecture according to a second embodiment of the invention;

FIG. 4 is a functional block diagram showing a system architecture according to a third embodiment of the invention;

FIG. 5 is a functional block diagram showing a system architecture according to a fourth embodiment of the invention;

FIG. 6 is a functional block diagram showing a system architecture according to a fifth embodiment of the invention; and

FIG. 7 is a functional block diagram showing a system architecture according to a sixth embodiment of the invention.

### DETAILED DESCRIPTION

The present invention will be apparent from the following detailed description, which proceeds with reference to the accompanying drawings, wherein the same references relate to the same elements.

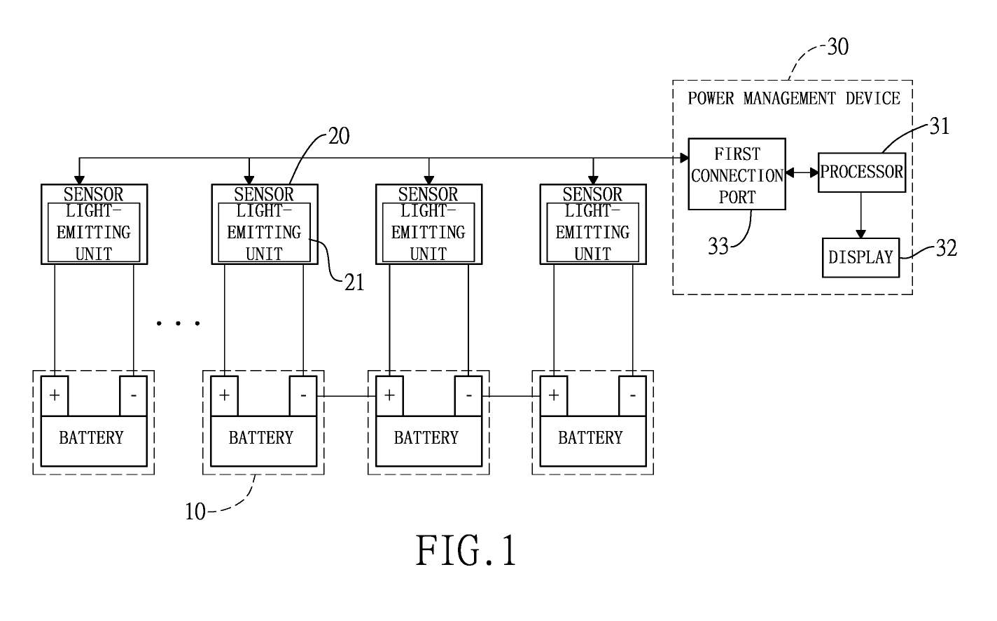

Please refer to FIG. 1, which shows a first system architecture according to a first embodiment of a power management system that displays background colors to indicate battery statuses. The power management system can be used in a control room. The power management system includes at least one battery set 10, at least one sensor 20, and a power management device 30. The at least one sensor 20 is each connected to the respective battery set 10 and the power management device 30. In this embodiment, the at least one battery set 10 includes a plurality of battery sets 10, and the at least one sensor 20 includes a plurality of sensors 20. The battery sets 10 are connected in series. In the first system architecture of the power management system, each of the battery sets 10 has only one battery. The number of the sensors 20 corresponds to that of the battery sets 10, so that each of the battery sets 10 is connected to a corresponding sensor 20. The power management device 30, the sensors 20, and the battery sets 10 form a power group. In this embodiment, the battery sets 10 can store electrical power as well as supply the stored electrical power.

The power management device 30 includes a processor 31, a display 32, and a first connection port 33. The processor 31 is connected to the display 32 and the first connection port 33, and the first connection port 33 is connected to the sensor 20. In this embodiment, the display 32 is a liquid crystal display (LCD) that can simultaneously display both background color and text messages, just background color, or just text messages.

The sensor 20 detects a current status of the battery set 10, such as the capacity, temperature, and voltage of the battery set. The sensor 20 sends detection information via the first connection port 33 to the processor 31 according to the detected battery status. The processor 31 generates corresponding status information according to the detection information, and sends the status information to the display 32, thereby driving the display 32 to show a corresponding background color indicative of the current status of the battery set 10.

For example, suppose that a battery set 10 severely deteriorates in terms of efficiency or is out of order. The display 32 uses a background color with a warning effect, such as red or orange, to show the status of the battery set 10. The aforementioned colors are only examples and should not be treated as limitations to the present invention. A maintenance person can quickly and directly know the statuses of the battery sets 10 by checking the background colors of the corresponding displays 32, thereby quickly identifying the faulty battery set 10. Besides, the maintenance person can manipulate the power management device 30 on site so that the displays 32 show the received status information in text messages, enabling the maintenance person to identify the status of the faulty battery set 10 and to quickly know which battery set 10 is broken for assurance of fast troubleshooting.

When the status of one of the battery sets 10 is good, the corresponding display 20 uses a background color indicative of a normal or safe situation, such as green or blue, to show the status of the battery set 10. The aforementioned colors are only examples and should not be treated as limitations to the present invention. Since using colors to show the status of each of the battery sets 10 is simple and intuitive, the maintenance person can quickly distinguish normal battery groups from the broken one. During maintenance, the maintenance person can conveniently learn the statuses of the battery sets 10 by looking at the background colors of the displays 20.

In this embodiment, the sensor 20 further includes a light-emitting unit 21 with the color of emitted light being the same as the background color of the display 32. More specifically, when the display 32 shows red background color, the processor 31 sends a corresponding driving signal to the sensor 20 via the first connection port 33, making the light-emitting unit 21 emit the corresponding red light. Having the same color for the light emitted from the light-emitting unit 21 and the background color of the display 32 enables the maintenance person to more accurately and quickly identify the faulty battery set.

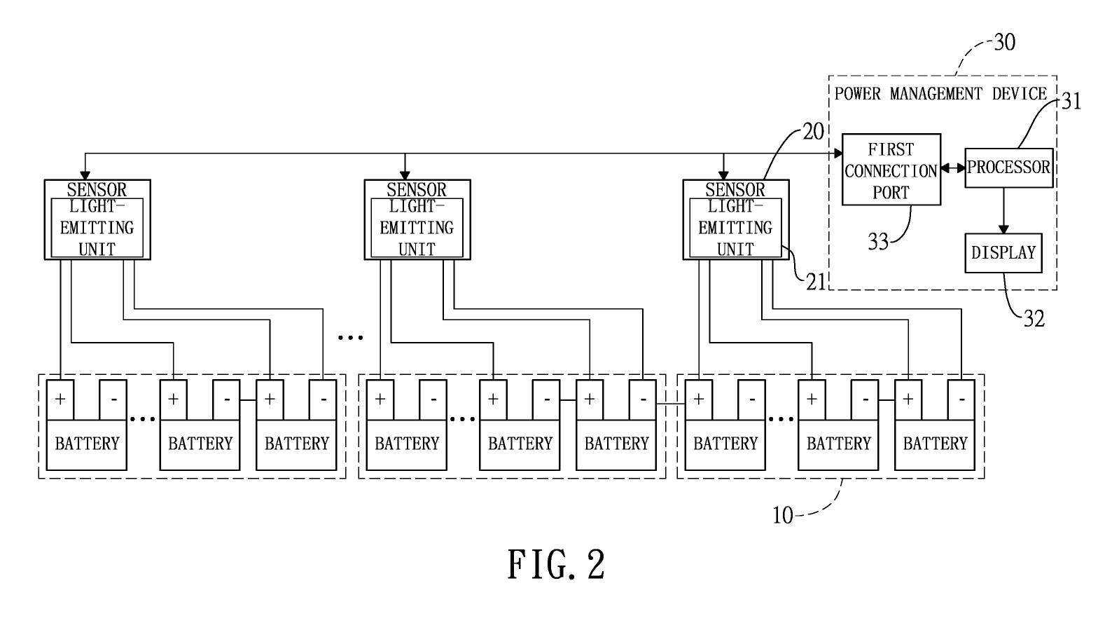

FIG. 2 shows a second system architecture according to the first embodiment of a power management system that displays background colors to indicate battery statuses. The second system architecture differs from the first system architecture in that each of the battery sets 10 has a plurality of batteries connected in series.

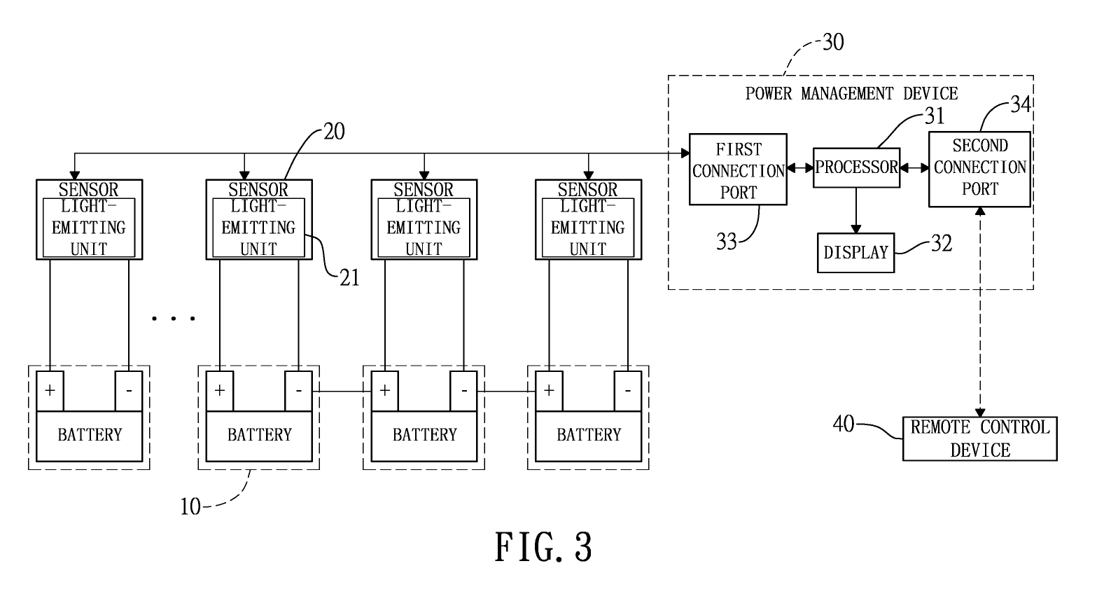

Please refer to FIG. 3 for a second embodiment of a power management system that displays background colors to indicate battery statuses. The second embodiment is roughly the same as the first embodiment, except that the second embodiment further includes a remote control device 40 and the power management device 30 further includes a second connection port 34. The second connection port 34 is connected to the remote control device 40 in a wired or wireless way. In this embodiment, the remote control device 40 is a remote monitoring and control computer.

The power management device 30 transmits the status information to the remote control device 40, for the maintenance person to know the status of the battery set 10. This makes it much easier for the maintenance person to repair the faulty battery set 10 on site.

In this embodiment, through the function of locating or finding device, the remote control device 40 sends setting information to the power management device 30 to change the background color of the display 32. The maintenance person can thus conveniently locate the power management device 30 according to the background color of the display 32.

In this embodiment, the remote control device 40 further sends setting information to the power management device 30 to change the background color of the display 32. After receiving the setting information, the power management device 30 further sends a driving signal corresponding to the setting information to the sensor 20 to control the light-emitting color of the light-emitting unit 21 to be the same as the background color of the display 32. In other words, the remote control device 40 can remotely control the background color of the light-emitting unit 21 of one of the sensors 20 associated with the corresponding battery set 10.

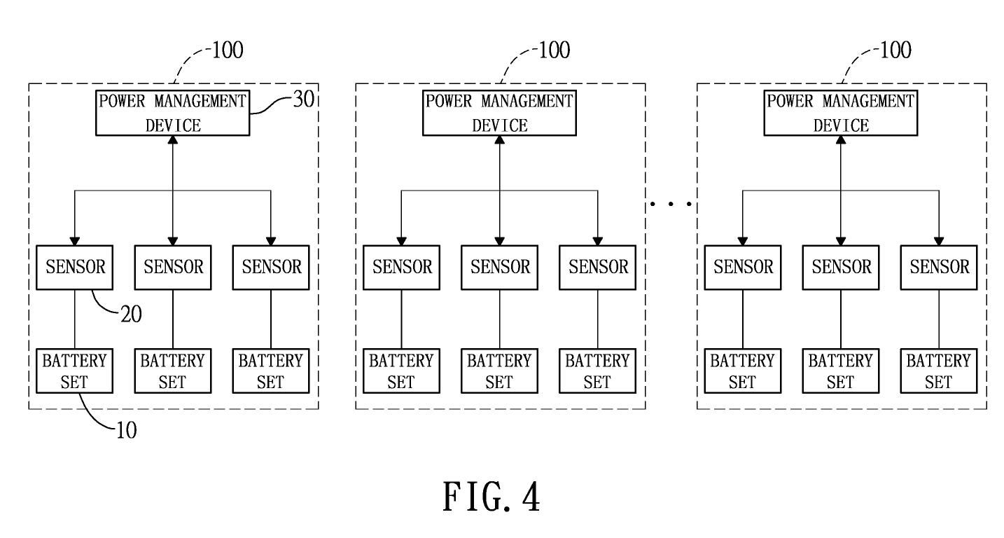

A third embodiment of a power management system that displays background colors to indicate battery statuses is shown in FIG. 4. The third embodiment is roughly the same as the first embodiment, except that the third embodiment includes multiple power groups 100. Each of the power groups 100 includes a plurality of battery sets 10, a plurality of sensors 20, and a power management device 30. Each of the power management devices 30 is connected to the sensors 20 of a corresponding power group 100. Each of the sensors 20 is connected to a respective one of the associated battery sets 10 of the corresponding power group 100. This embodiment employs three power groups 100, which are taken as an example for the purpose of illustration but not limitations to the present invention. The control room may have multiple power groups 100. Through the display associated with the power management device 30 in each of the power groups 100, the maintenance person can directly and quickly know which power group and which battery set 10 have problems according to the background color of the display associated with the power management device 30. The maintenance person can operate the power management device 30 to let the display show the received status information in text, thereby ascertaining any faulty battery set 10 or the status of any battery set 10 in the power groups 100.

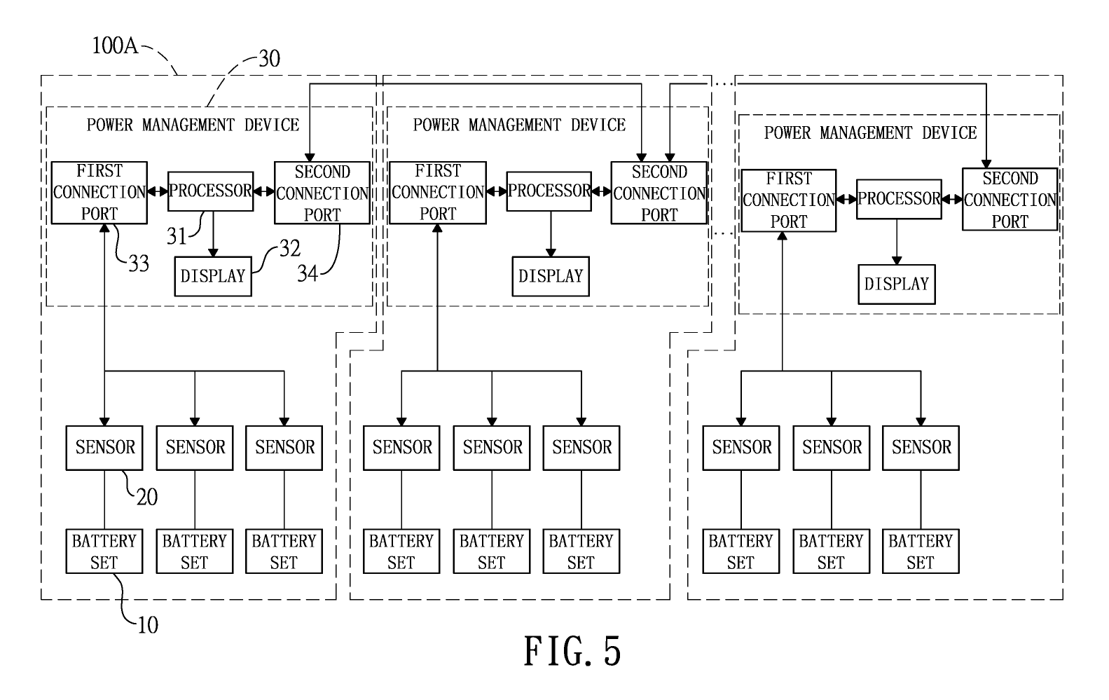

Please refer to FIG. 5 for a fourth embodiment of a power management system that displays background colors to indicate battery statuses. The fourth embodiment is roughly the same as the second embodiment, except for the absence of the remote control device 40. In the fourth embodiment the power management system includes multiple power groups 100A, each of which includes a plurality of battery sets 10, a plurality of sensors 20, and a power management device 30. The power management device 30 is connected to the sensors 20 in a same power group 100A. Each of the sensors 20 is connected to a corresponding battery set 10 in a same power group 100A. The power management devices 30 of the multiple power groups 100A are connected in series via the second connection ports 34 in the form of a daisy chain topology.

In the daisy chain topology, the foremost power group 100A is taken as a primary power group 100A while the rest of the power groups 100A are auxiliary power groups 100A. The background color of the display 32 associated with each of the auxiliary power groups 100A and the background color of the display 32 associated with the primary power group 100A have different shades of colors. For example, the display 32 of the primary power group 100A uses a darker background color, and the displays 32 of the auxiliary power groups 100A use a lighter background color. Alternatively, the display 32 of the primary power group 100A uses a lighter background color, and the displays 32 of the auxiliary power groups 100A use a darker background color. The maintenance person can readily know the group relation of the power groups 100A according to the background colors of the displays 32 of the primary power group 100A and the auxiliary power groups 100. As an explicit example, the display 32 of the primary power group 100A uses a dark red background color, and the displays 32 of the auxiliary power groups 100A use a light red background color. Those examples are provided for the purpose of illustration and should not be used to limit the scope of the invention. The colors can be set according to practical needs. By connecting power supplies with correlation or for the same power supply targets in the control room in a daisy chain topology, the maintenance person can easily manage the power supplies through the topology.

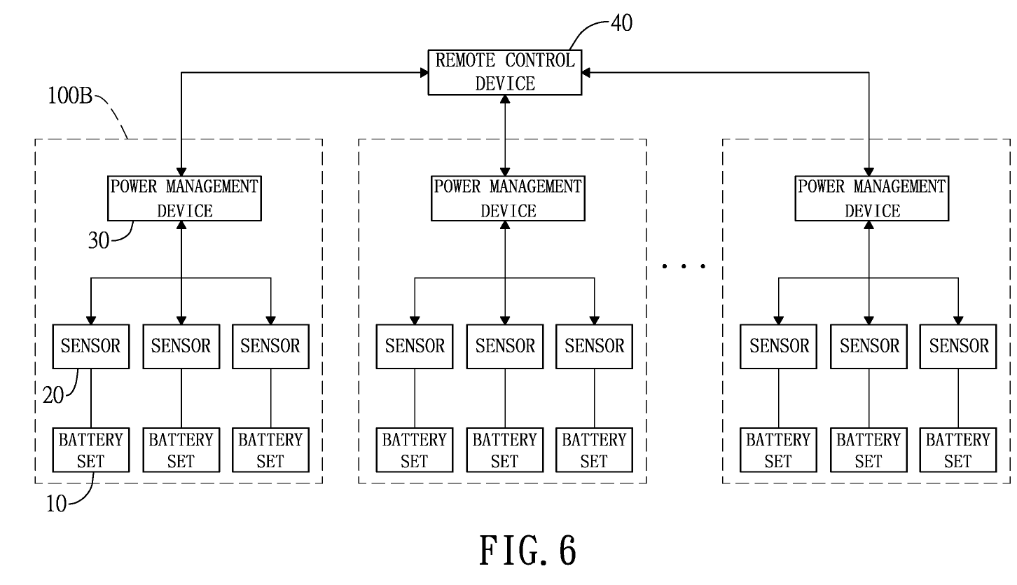

FIG. 6 shows a fifth embodiment of a power management system that displays background colors to indicate battery statuses. The fifth embodiment is roughly the same as the second embodiment, except that the former has multiple power groups 100B. Each of the power groups 100B includes a plurality of battery sets 10, a plurality of sensors 20, and a power management device 30. Each of the power management devices 30 of the multiple power groups 100B is connected to the corresponding sensors 20 in a same power group 100B. Each of the sensors 20 is connected to a corresponding battery set 10 in the same power group 100B.

The remote control device 40 is connected to all of the power management devices 30 for the maintenance person to conveniently manage the power groups 100B via the remote control device 40. There are two ways for the maintenance person to manage the power groups 100B via the remote control device 40. In the first scenario, when one of the battery sets 10 associated with a corresponding power management device 30 is out of order, the display 32 of the corresponding power management device 30 is controlled to show a corresponding background color while status information about the faulty battery set 10 is sent to the remote control device 40 at the same time. The remote control device 40 displays the received status information for the maintenance person to know about the faulty battery set 10. In this scenario, the power management device 30 proactively notifies the remote control device 40 of the broken battery set.

In the second scenario, when one of the battery sets 10 associated with a corresponding power management device 30 is out of order, the corresponding status information is sent by the corresponding power management device 30 to the remote control device 40. The remote control device 40 then shows the received status information for the maintenance person to know that the battery set 10 is broken. Moreover, the remote control device 40 returns the setting information to the corresponding power management device 30 that sends the status information to control the connected display 32 to show a corresponding background color. The maintenance person thus knows which battery set 10 of a corresponding power group 100B is out of order. The second scenario makes use of active locating. The remote control device 40 changes the background color of the display 32 of a corresponding power management device 30 according to the received status information, enabling the maintenance person to quickly locate a faulty battery set 10 in the corresponding power group 100B.

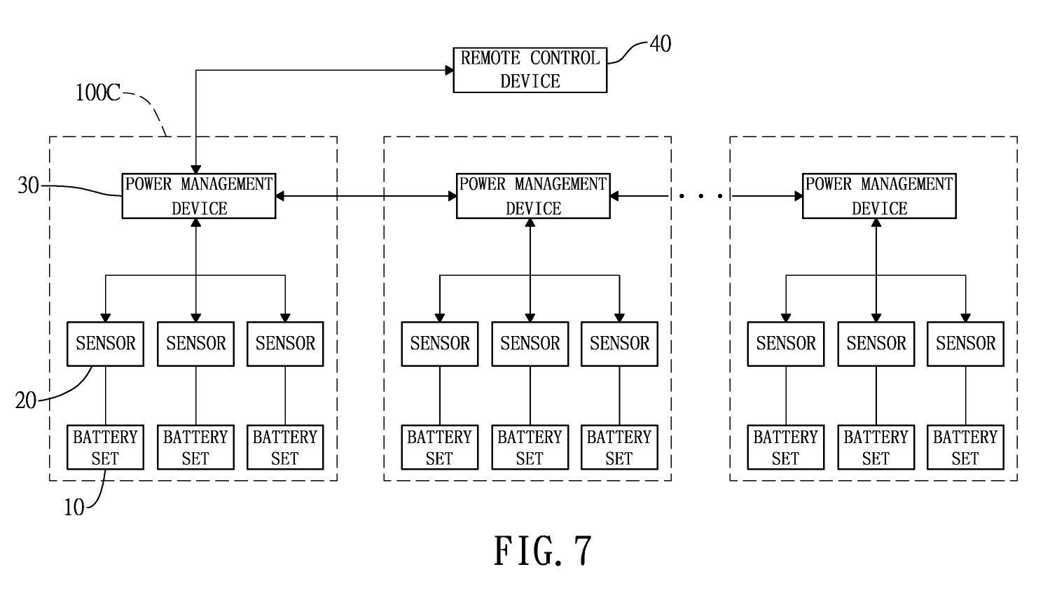

With reference to FIG. 7, a sixth embodiment of a power management system that displays background colors to indicate battery statuses is roughly the same as the fifth embodiment, except that the connection relation between the power management device 30 and the remote control devices 40 in the power groups 100C is different. In the sixth embodiment, the power management devices 30 of the power groups 100C are connected in series in the form of a daisy chain topology. The power management device 30 of the foremost power group 100C in the daisy chain topology is connected to the remote control device 40. The power group 100C directly connected to the remote control device 40 functions as a primary power group 100C. The rest of power groups 100C are auxiliary power groups 100C. The background colors of the displays of the auxiliary power groups 100C are set to be the same as the background color of the display of the primary power group 100C, but with different shades of colors. By connecting the power groups 100C with correlation or for same power supply targets in the control room in a daisy chain topology, the maintenance person can easily manage the power groups 100C through the topology.

By virtue of sensed signals associated with current status of the battery sets 10 received by the power management device 30, the power management device 30 generates status information according to the sensed signals and controls the display 32 thereof to display a corresponding background color according to the status information. Therefore, the maintenance person on site can directly see the background color on the display 32 to conveniently and quickly identify a corresponding power group 100 and a faulty battery set 10 in the corresponding power group 100 for speeding up maintenance and facilitating easy management.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A power management system displaying background colors to indicate battery statuses, comprising:
at least one battery set, each of which includes a plurality of batteries for providing and storing electrical power;
at least one sensor, each of which is connected to a corresponding battery set to detect a current status of the corresponding battery set and generate detection information; and
at least one power management device, each of which includes a processor, a first connection port, and a display; wherein the first connection port is connected to the at least one sensor to receive the detection information and send the detection information to the processor, the processor generates status information according to the received detection information, and enables the display to show a background color corresponding to the status information.

2. The power management system of claim 1, further comprising a remote management device connected to the at least one power management device; wherein one of the at least one power management device sends the status information to the remote management device, the remote management device sends setting information to said power management device according to the received status information, and said power management device sets the background color of the display of said power management device according to the received setting information.

3. The power management system of claim 1, wherein
the at least one battery set includes a plurality of battery sets, each of which has at least one battery;
the at least one sensor includes a plurality of sensors, each of which is correspondingly connected to a respective one of the batteries sets; and
the at least one power management device includes a plurality of power management devices, each of which is connected to corresponding sensors, and each of the power management devices and the sensors and the battery sets connected to the power management device form a power group.

4. The power management system of claim 3, further comprising a remote management device connecting to each of the power management devices; wherein one of the power management devices sends status information to the remote management device, the remote management device sends setting information to said power management device to set the background color of the display associated with said power management device.

5. The power management system of claim 1, further comprising:
the at least one battery set includes a plurality of battery sets, each of which has at least one battery;
the at least one sensor includes a plurality of sensors, each of which is correspondingly connected to a respective one of the batteries sets; and
the at least one power management device includes a plurality of power management devices, each of which is connected to corresponding sensors, each of the power management devices and the sensors and the battery sets connected to the power management device form a power group, each of the power management devices includes a second connection port, and the second connection ports of the power management devices are connected in series for the power groups to be arranged in the form of a daisy chain topology.

6. The power management system of claim 5, further comprising a remote management device, wherein the remote management device is connected to the power management device of one of the power groups, the power management device sends the detection information to the remote management device via the power management device connected to the remote management device, and the remote management device sends setting information to the corresponding power management device via the connected power management device to set the background color of the display of the corresponding power management device.

7. The power management system of claim 5, wherein the power group at the beginning of the daisy chain topology is a primary power group and the rest of the power groups connected in series are auxiliary power groups, and the background color of the display of each of the auxiliary power groups and the background color of the display of the primary power group have different shades of colors.

8. The power management system of claim 6, wherein the power group at the beginning of the daisy chain topology is a primary power group and the rest of the power groups connected in series are auxiliary power groups, and the background color of the displays of the auxiliary power groups and the background color of the display of the primary power group have different shades of colors.

9. The power management system of claim 1, wherein each of the at least one sensor includes a light-emitting unit, the processor of one of the at least one power management device sends a driving signal to the sensor to control the color of light emitted from the light-emitting unit to be the same as the background color of the display of the power management device.

10. The power management system of claim 2, wherein each of the at least one sensor includes a light-emitting unit, and the processor of one of the at least one power management device sends a driving signal to the sensor to control the color of light emitted from the light-emitting unit to be the same as the background color of the display of the power management device.

11. The power management system of claim 3, wherein each of the sensors includes a light-emitting unit, and the processor of one of the power management devices sends a driving signal to the sensor to control the color of light emitted from the light-emitting unit to be the same as the background color of the display of the power management device.

12. The power management system of claim 4, wherein each of the sensors includes a light-emitting unit, and the processor of one of the power management devices sends a driving signal to the sensor to control the color of light emitted from the light-emitting unit to be the same as the background color of the display of the power management device.

13. The power management system of claim 5, wherein each of the sensors includes a light-emitting unit, and the processor of one of the power management devices sends a driving signal to the sensor to control the color of light emitted from the light-emitting unit to be the same as the background color of the display of the power management device.

14. The power management system of claim 6, wherein each of the sensors includes a light-emitting unit, and the processor of one of the power management devices sends a driving signal to the sensor to control the color of light emitted from the light-emitting unit to be the same as the background color of the display of the power management device.

15. The power management system of claim 7, wherein each of the sensors includes a light-emitting unit, and the processor of one of the power management devices sends a driving signal to the sensor to control the color of light emitted from the light-emitting unit to be the same as the background color of the display of the power management device.

16. The power management system of claim 8, wherein each of the sensors includes a light-emitting unit, and the processor of one of the power management devices sends a driving signal to the sensor to control the color of light emitted from the light-emitting unit to be the same as the background color of the display of the power management device.

17. The power management system of claim 1, wherein:
the at least one battery set includes a plurality of battery sets, each of which has at least one battery;
the at least one sensor includes a plurality of sensors, each of which is correspondingly connected to a respective one of the batteries sets; and
the at least one power management device includes one power management device connected to the plurality of the sensors.
